(19) United States
(12) Patent Application Publication
(10) Pub. No.: US 2024/0419581 A1
(43) Pub. Date: Dec. 19, 2024

(54) SYSTEM AND METHOD FOR SOFTWARE TEST ANALYSIS

(71) Applicant: SeaLights Technologies Ltd., Ra'anana (IL)

(72) Inventors: Alon Eizenman, Kfar Saba (IL); Eran Sher, Kfar Saba (IL); Gal Halup, Kfar Saba (IL); Jecky Toledo, Kfar Saba (IL)

(21) Appl. No.: 18/738,409

(22) Filed: Jun. 10, 2024

Related U.S. Application Data
(60) Provisional application No. 63/508,403, filed on Jun. 15, 2023.

(51) Int. Cl. G06F 11/36

(52) U.S. Cl. CPC G06F 11/3692

(57) ABSTRACT

A system and method for analyzing test results and build mapping to determine a root cause of a particular behavior.

### FIELD OF THE INVENTION

The present invention is of a system and method for software test analysis and in particular, of such a system and method for analyzing test results and build mapping to determine a root cause of a particular behavior.

### BACKGROUND OF THE INVENTION

Various methods are known in the art for analyzing causation within test results for assuring quality for a software. Such test results help to determine whether such code executes in an expected manner according to the expected parameters and is therefore showing expected behavior.

Correlating test results to software functions and behaviors can be difficult.

### BRIEF SUMMARY OF THE INVENTION

The present invention overcomes the drawbacks of the background art by providing a system and method for analyzing software tests, preferably including test results and build mapping, to analyze software behavior, for example to determine a root cause of a particular behavior.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involves performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, a processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1A shows a non-limiting, exemplary system for analyzing builds to determine which tests are relevant;

FIG. 1B shows a non-limiting, detailed example of a build mapper;

FIG. 1C shows a non-limiting, exemplary method for analyzing tests to determine a root cause of a particular behavior;

FIG. 2 shows an additional non-limiting, exemplary build mapper;

FIGS. 3A and 3B relate to non-limiting exemplary systems and flows for providing information to an artificial intelligence system with specific models employed and then analyzing it;

FIG. 4 shows a non-limiting, exemplary system and flow for ensemble learning;

FIG. 5 shows a non-limiting, exemplary method for training a machine learning model;

FIG. 6 shows a non-limiting, exemplary method for analyzing a plurality of tests to determine underlying behavior of the code under test, each test itself or a combination thereof;

FIG. 7A shows a non-limiting, exemplary system for troubleshooting and root cause analysis;

FIG. 7B shows a non-limiting, exemplary method for troubleshooting and root cause analysis;

FIG. 8 shows a non-limiting, exemplary method for analyzing a plurality of tests to determine behavior of overlapping tests;

FIG. 9 shows a non-limiting, exemplary method for span analysis; and

FIG. 10 shows a non-limiting, exemplary method for flaky test detection.

### DESCRIPTION OF AT LEAST SOME EMBODIMENTS

Root cause analysis links the results of a particular test of the function of code to one or more aspects of the code. For example, root cause analysis may be applied to look for failed tests, in which the code did not function as expected, and may then be used to help determine the cause of the failure. Root cause analysis may also be used to locate tests with unexpected or undesirable behavior, such as running slowly, to determine whether the code or the test itself is the source of the problem.

As described herein, preferably a user is able to search for failed tests and also the history of the test results, for example to determine whether the test itself is at fault. Preferably these results can be linked to changes in the code, such as the build map. Optionally the results may be analyzed and/or filtered according to one or more of apps, builds, branches, time range, labs, test stages, test names, etc.

The user may also optionally select the reference test run for a comparison between two sets of test results, whether for different runs of the same test or runs of different tests. The comparison result may be further enriched according to time, changes to the underlying code, changes to the test and so forth.

The root cause search space preferably indicates suspected areas in the failed test with highlighting.

The comparison may further use related tests and related spans (functional groups in relation to the code) from other tests; code changes and/or test metadata.

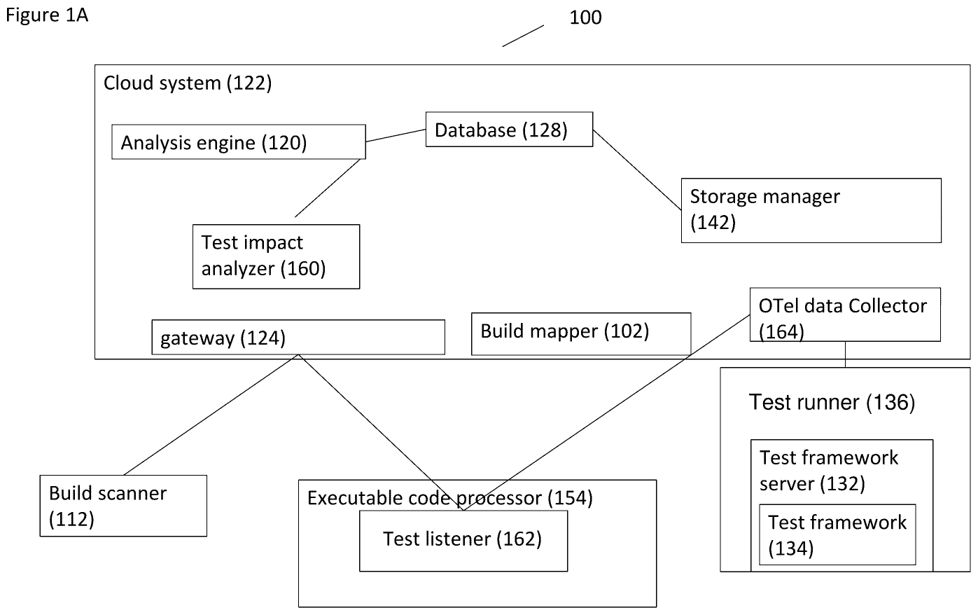

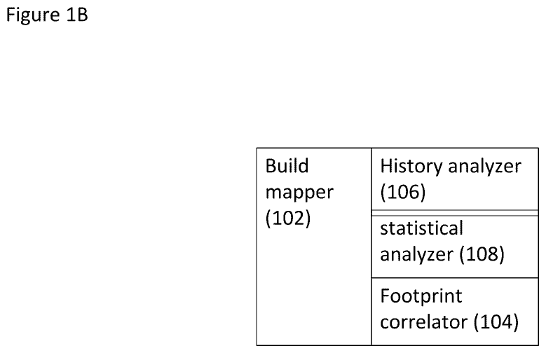

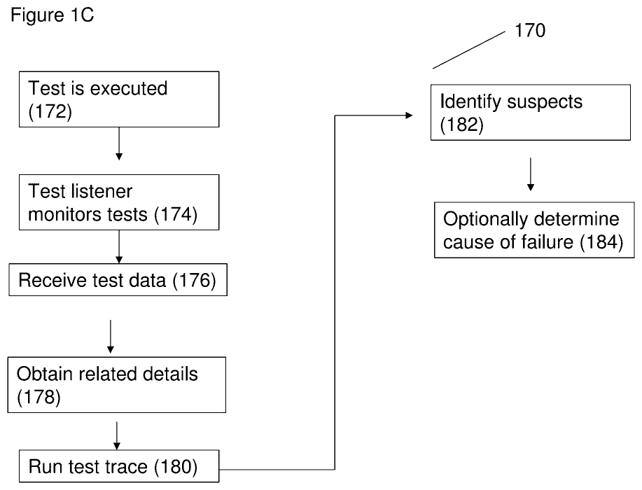

FIG. 1A shows a non-limiting, exemplary system for analyzing builds to determine which tests are relevant.

In the system 100, executable code processor 154 is executing a test. Test listener 162 monitors the test and its results, and causes one or more tests to be performed. These tests may be performed through a test framework server 132, which executes a test framework 134. Test framework 134 preferably determines the code coverage for new, modified, or existing code and may also receive information from cloud system 122 regarding previous tests. Test framework 134 may then calculate the effect of a new test as to whether or not it will increase code coverage or whether it will not increase test code coverage, and in particular test coverage for specific code.

Test information is sent first to a storage manager 142 and then to analysis engine 120, optionally through a database 128. Analysis engine 120 determines whether or not test code coverage should be updated, how it should be updated, whether any code has not been tested, and so forth. This information is stored in database 128 and is also passed back to gateway 124.

As shown, the test listener functions of FIG. 1 may be performed by test listener 162, alone or in combination with analysis engine 120.

A build mapper 102 preferably determines the relevance of one or more tests, according to whether the code that is likely covered by such tests has changed. Such a determination of likely coverage and code change in turn may be used to determine which tests are relevant, and/or the relative relevance of a plurality of tests. Build mapper 102 is preferably operated through cloud system 122.

Build mapper 102 preferably receives information about a new build and/or changes in a build from a build scanner 112. Alternatively, such functions may be performed by analysis engine 120. Build mapper then preferably receives information about test coverage, when certain tests were performed and when different portions of code were being executed when such tests were performed, from test listener 162 and/or analysis engine 120.

Build mapper 102 preferably communicates with a plurality of additional components, such as a footprint correlator 104 for example, as shown with regard to FIG. 1B, for determining which tests relate to code that has changed, or that is likely to have changed, as well as for receiving information regarding code coverage. Footprint correlator 104 in turn preferably communicates such information to a history analyzer 106 and a statistical analyzer 108 (also shown in FIG. 1B). History analyzer 106 preferably assigns likely relevance of tests to the new or changed code, based on historical information. Such likely relevance is then sent to statistical analyzer 108. Statistical analyzer 108 preferably determines statistical relevance of one or more tests to one or more sections of code, preferably new or changed code. For example, such statistical relevance may be determined according to the timing of execution of certain tests in relation to the code that was being executed at the time. Other relevance measures may also optionally be applied. Information regarding the results of the build history map and/or statistical model are preferably stored in a database, such as database 128.

Turning back to FIG. 1A, for determining the relative or absolute impact of a test, and optionally for selecting one or more preferred tests, a test impact analyzer 160 is shown as part of cloud system 122. Test impact analyzer 160 may have part or all of its functions incorporated in build mapper 102 or at another location (not shown). Test impact analyzer 160 is preferably able to recommend one or more tests to be performed, for example according to a policy set by the user, according to one or more rules or a combination thereof. Tests may be given a preference, relative or absolute, according to such a policy or such rules.

Non-limiting examples of such rules include a preference for impacted tests, previously used at least once, that cover a footprint in a method that changed in a given build. Also preferably recently failed tests may be performed again. New tests that were added recently or modified tests may be performed again. Tests that were recommended in the past but were not executed since then may have a preference to be performed.

Tests that are covering code that is being used in production may be preferred, particularly in case of inclusion of one of the above rules. Other code related rules may include but are not limited to tests that are covering code that was modified multiple times recently, and/or tests that are covering code that is marked manually or automatically as high risk code.

A non-limiting example of a user determined policy rule is the inclusion of an important test recommended by the user so that it is always executed in each selective run of the tests.

When a user selects the option of running only the recommended tests, it is done by defining a selective run policy that may include information about the occasions when to run the selective tests list or full test list, that can be based on number or tests executions in a day/week/month, or every number of test executions, or between a certain time frame.

Test impact analyzer 160 preferably performs test impact analytics, based on the above. Test Impact Analytics is based on the correlation between a test coverage and code changes. It may for example include giving a preference to the tests that have footprints in methods that were modified in a given build. Test impact analyzer 160 is supported by calculations of the code coverage for each test that was executed in any given test environment. The per test coverage is calculated based on a statistical correlation between a given time frame of the tests that were executed with the coverage information being collected during this time frame, as described above and in greater detail below.

Also as described in greater detail below, a machine learning system is preferably used to refine the aforementioned correlation of tests to coverage data. Such a system is preferably applied, due to the fact that test execution is not deterministic by nature and the fact that tests may run in parallel, which may render the results even more non-deterministic.

Optionally, test impact analyzer 160 determines that a full list of tests is to be run, for example but without limitation under the following conditions: 1. User selection of full run. 2. When server bootstrapping code has been modified. 3. Configuration or environment variables have been modified.

Although not shown, cloud system 122 preferably features a processor and a memory, or a plurality of these components, for performing the functions as described herein.

Functions of the processor preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as the memory described above in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, the memory is configured for storing a defined native instruction set of codes. The processor is configured to perform a defined set of basic operations in response to receiving a corresponding basic instruction selected from the defined native instruction set of codes stored in the memory. For example and without limitation, the memory may store a first set of machine codes selected from the native instruction set for receiving information from build scanner 112 about a new build and/or changes in a build; a second set of machine codes selected from the native instruction set for receiving information about test coverage, when certain tests were performed and when different portions of code were being executed when such tests were performed, from test listener 162 and/or analysis engine 120; and a third set of machine codes from the native instruction set for operating footprint correlator 104, for determining which tests relate to code that has changed, or that is likely to have changed, as well as for receiving information regarding code coverage.

The memory may store a fourth set of machine codes from the native instruction set for communicating such changed code and/or code coverage information to a history analyzer 106, and a fifth set of machine codes from the native instruction set for assigning likely relevance of tests to the new or changed code, based on historical information. The memory may store a sixth set of machine codes from the native instruction set for communicating such changed code and/or code coverage information to a statistical analyzer 108, and a seventh set of machine codes from the native instruction set for determining statistical relevance of one or more tests to one or more sections of code, preferably new or changed code.

Preferably an OTel data Collector 164 communicates with test listener 162, to obtain information about the test performed and the results of the test. For example, OTel data Collector 164 may trace the test execution and results through Open Telemetry or a similar suitable process. OTel data Collector 164 also preferably receives test information, including the type of test and parameters involved, from test runner 136. One or both of test listener 162 and/or test runner 136 may provide such information as details regarding the execution environment, the particular build being tested, and so forth.

Analysis engine 120 then receives the test results from test listener 162 and the test details (including the framework) from test runner 136, as well as the test trace information from OTel data Collector 164. Analysis engine 120 then analyzes the result of executing at least one test, based on the received information. The analysis may include determining whether a test executed correctly, whether a fault was detected, and so forth.

Preferably, analysis engine 120 also receives information regarding the build and changes to the code from build mapper 102. Such build information assists in the determination of whether a particular test relates to a change in the code.

As described in greater detail below, analysis engine 120 preferably at least may be used to determine the root cause of a particular behavior, including but not limited to code failure at execution, inefficiently executing code, inefficiently executing tests and so forth.

Also as described in greater detail below, analysis engine 120 preferably at least assists in determining whether a test displays erratic or “flaky” behavior, such that incorrect or undesirable test results may actually be caused by the test itself. Analysis engine 120 also preferably at least assists in determining whether one or more tests are executing efficiently, and also whether there are changes in testing performance.

Analysis engine 120 also at least assists in determining whether the executed code is performing well. By “well” it is meant that the end result of the code is reached at a reasonable speed and with reasonable consumption of computer resources.

Optionally the components shown in FIGS. 1A and 1B are not collocated. For example, test listener 162 and test runner 136 may be located separately from build mapper 102 and/or build scanner 112, each of which may be located at cloud 122 or at a separate location.

FIG. 1C shows a non-limiting, exemplary method for analyzing tests to determine a root cause of a particular behavior. As shown, a method 170 begins with at least one test being executed at 172, as previously described. The previously described test listener then listens for the results of the test at 174. The results of the test are received by the test listener at 176 and are preferably passed to the analysis engine as previously described. At 178, related details, including but not limited to the parameters used for testing and for executing the code, the environment details and optionally also the build map, are preferably received by the analysis engine.

At 180, a test trace is run as previously described, for example according to a method such as Open Telemetry. The test trace results are also preferably provided to the analysis engine. At 182, one or more suspects are identified for a particular behavior. The behavior may relate to a fault or failure of some type, such as a fault or failure of test execution and/or a result showing a fault or failure of the code under test. The behavior may also relate to a difference, such as a differential speed of execution of the code and/or of the test. The one or more suspects relate to a potential cause for the underlying behavior. The suspects may be identified through an analysis performed by the analysis engine for example. At 184, optionally the cause for a failure is identified, by selecting one of the suspects as the root cause.

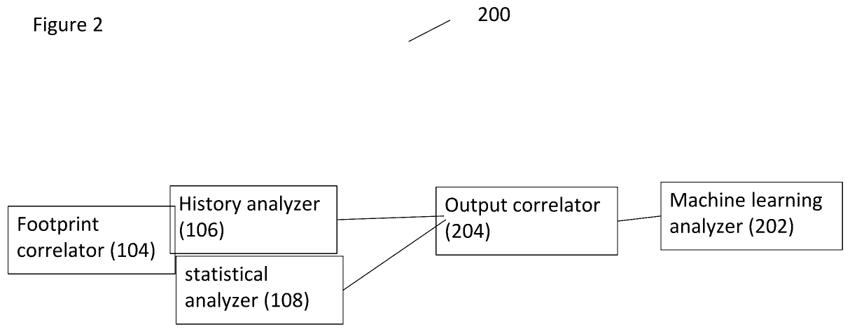

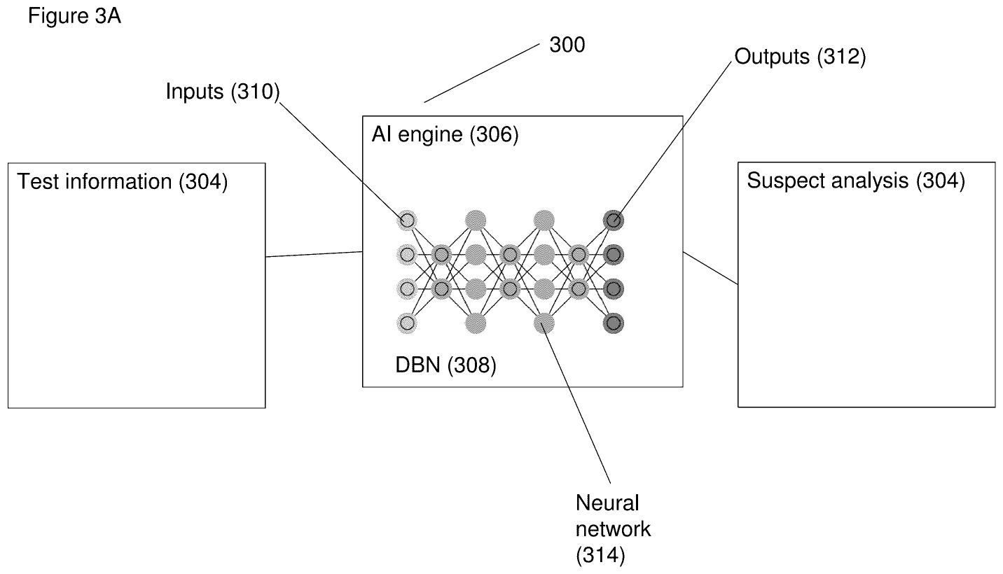

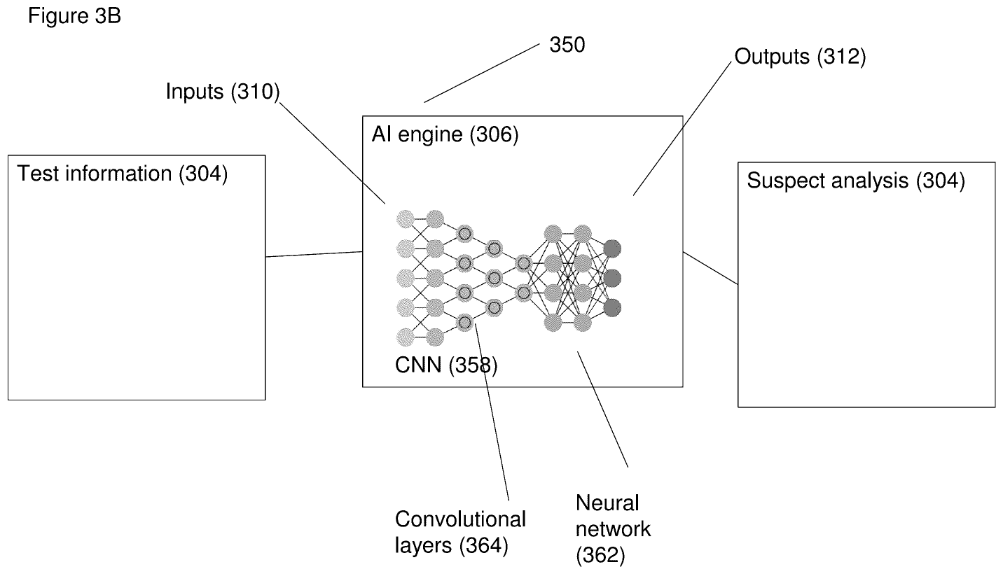

FIG. 2 shows a non-limiting, exemplary build mapper, in an implementation which may be used with any of FIGS. 1A-1C as described above, or any other system as described herein. The implementation may be operated by a processor with memory and/or another cloud system as described above. Components with the same numbers as in FIGS. 1A or 1B have the same or similar function. A build mapper 200 features a machine learning analyzer 202, which preferably receives information from history analyzer 106 and statistical analyzer 108. Machine learning analyzer 202 then preferably applies a machine learning model, non-limiting examples of which are given in FIGS. 3A and 3B, to determine the relative importance of a plurality of tests to particular code, files or methods.

More preferably, an output correlator 204 receives information from history analyzer 106 and statistical analyzer 108, and transmits this information to machine learning analyzer 202. Such transmission may enable the information to be rendered in the correct format for machine learning analyzer 202. Optionally, if history analyzer 106 and statistical analyzer 108 are also implemented according to machine learning, or other adjustable algorithms, then feedback from machine learning analyzer 202 may be used to adjust the performance of one or both of these components.

Once a test stage finishes executing, optionally with a “grace” period for all agents to submit data (and the API gateway to receive it), then preferably the following data is available to machine learning analyzer 202: a build map, a test list, and time slices. A Build map relates to the code of the build and how it has changed. For example, this may be implemented as a set of unique IDs +code element IDs which are persistent across builds. The test list is a list of all tests and their start/end timing. Time slices preferably include high-time-resolution slicing of low-coverage-resolution data (e.g. file-level hits [or method hits] in 1-second intervals).

The first step is to process the data to correlate the footprint per test (or a plurality of tests when tests are run in parallel). The second step is model update for the machine learning algorithm. Based on the build history, the latest available model for a previous build is loaded (ideally this should be the previous build).

If no such model exists, it is possible to assume an empty model with no data, or an otherwise untrained machine learning algorithm. The model consists of a set of test+code element id mapping (which are the key) and a floating point number that indicates the correlation between the test and the code element id. Such correlation information is preferably determined by statistical analyzer 108. For example, a “1.0” means the highest correlation, whereas a 0 means no correlation at all (the actual numbers will probably be in between).

For any test+code element id, the method preferably updates each map element, such as each row, according to the results received. For example, updating may be performed according to the following formula: NewCorrelation[test i, code element id j]=OldCorrelation[test i, code element id j]*0.9+(0.1 if there is a hit, 0 otherwise). This type of updating is an example of a heuristic which may be implemented in addition to, or in place of, a machine learning algorithm. Preferably these coefficients always sum up to 1.0, so there is effectively a single coefficient that relates to the speed (number of builds). For example, it is possible to do a new statistical model after each set of tests run, optionally per build.

Next preferably a cleanup step is performed where old correlations are deleted for code elements that no longer exist in the new build. Optionally a further cleanup step is performed where old tests are deleted, and methods that are very uncorrelated with tests (e.g. <0.1).

Optionally tests are selected for implementation according to a variety of criteria, once the statistically likely relationship between a particular test that is executed, and the related code has been established. Such criteria may be determined according to test impact analytics. These test impact analytics consider the impact of the code and/or of the test on the code, in order to build a list of tests to be performed. Optionally the list is built according to the above described order of relative importance. The list may also comprise a plurality of lists, in which each list may contain a preferred order of tests. Such lists may be assigned for performance in a particular order and/or according to a particular time schedule. For example and without limitation, one list of a plurality of tests may be executed immediately, while another such list may be executed at a later time, which may for example and without limitation be a particular time of day or day of the week.

Another consideration for the creation of one or more lists is the implementation of a minimal set of tests as opposed to a full test review. For example, a list may contain a minimal necessary set of tests. Alternatively or additionally, at least one list may comprise a full set of tests only on code that the end user is actively using, or causing to execute. Such a list may be preferentially implemented, while a full set of tests on code that the user is not actively using may not be preferentially implemented, may be implemented with a delay or when resources are free, or may not be implemented at all.

The test impact analytics may include such criteria as preferred implementation of new and modified tests; tests selected by the user, failed tests, and/or tests that are selected according to code that actual end users cause to execute when the code is in production. Other important criteria for the code that may influence test selection include highly important code sections or code that is considered to be mission critical, as well as code that has required significant numbers of tests according to past or current criteria, with many interactions with other sections of code and/or with many new commits in the code.

FIGS. 3A and 3B relate to non-limiting exemplary systems and flows for providing information to an artificial intelligence system with specific models employed and then analyzing it.

Turning now to FIG. 3A as shown in a system 300, information from the output correlator 204 of FIG. 2 is preferably provided at 302. This information is then fed into an AI engine in 306 and a test relevance ranking is provided by the AI engine in 304. In this non-limiting example, AI engine 306 comprises a DBN (deep belief network) 308. DBN 308 features input neurons 310 and neural network 314 and then outputs 312.

A DBN is a type of neural network composed of multiple layers of latent variables (“hidden units”), with connections between the layers but not between units within each layer.

FIG. 3B relates to a non-limiting exemplary system 550 with similar or the same components as FIG. 3A, except for the neural network model. In this case, a neural network 362 includes convolutional layers 364, neural network 362, and outputs 312. This particular model is embodied in a CNN (convolutional neural network) 358, which is a different model than that shown in FIG. 3A.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv: 1702.01923v1 [cs. CL] 7 Feb. 2017).

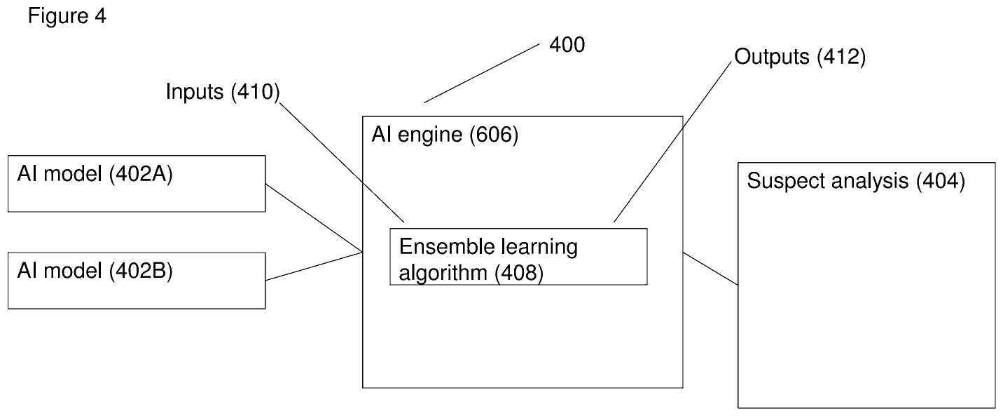

FIG. 4 shows a non-limiting, exemplary system and flow for ensemble learning. Such a system features a combination of different models of which two non-limiting examples are shown. In this non-limiting example, in the system 400 a plurality of AI inputs 410 are provided from a plurality of AI models 402, shown as AI models 402A and 402B. Such models may be any suitable models as described herein. The outputs of these AI models are then provided to AI engine 406, operating an ensemble learning algorithm 408. Ensemble learning algorithm 408 may feature any type of suitable ensemble learning method, including but not limited to, a Bayesian method, Bayesian optimization, a voting method, and the like. Additionally and alternatively, ensemble learning algorithm 408 may feature one or more additional neural net models, such as for example, without limitation a CNN or an encoder decoder model. Transform models in general may also be used as part of ensemble learning algorithm 408.

Outputs 412 from AI engine 406 may then be provided as test relevance ranking 404, as previously described.

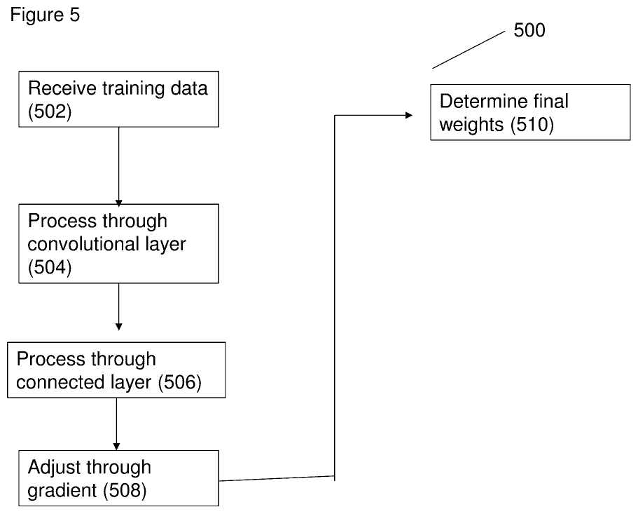

FIG. 5 shows a non-limiting, exemplary method for training a machine learning model. As shown in a flow 500, the training data is received in 502 and it is processed through the convolutional layer of the network in 504. This process is used if a convolutional neural net is used, which is the assumption for this non-limiting example, as shown for example with regard to FIG. 3B. After that the data is processed through the connected layer in 506 and adjusted according to a gradient in 508. Typically, a steep descent gradient is used in which the error is minimized by looking for a gradient. One advantage of this is it helps to avoid local minima where the AI engine may be trained to a certain point but may be in a minimum which is local, but is not actually the true minimum for that particular engine. The final weights are then determined in 510 after which the model is ready to use.

In terms of provision of the training data, preferably balanced and representative training data is used. The training data is preferably representative of the types of actual data which will be processed by the machine learning model. The training data preferably comprises test results, including without limitation success or failure of the test itself and of the code under test; behavior of the test itself and of the code under test; details such as tested parameters and environment details; information regarding changes to code; and/or test trace results as previously described.

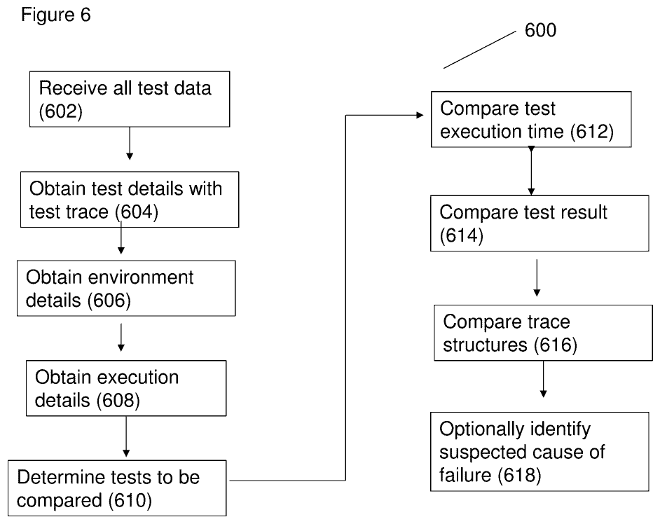

FIG. 6 shows a non-limiting, exemplary method for analyzing a plurality of tests to determine underlying behavior of the code under test, each test itself or a combination thereof. As shown, a method 600 starts by receiving all relevant test data at 602. The test data preferably comprises the previously described data, including without limitation, test results and also behavior of the test, as well as behavior of the code under test. At 604, test details and the test trace are preferably received as previously described. At 606 the previously described environment details are received. At 608 the previously described execution details are received.

At 610, the tests to be compared are determined. For example, the same test may be compared to itself after a plurality of executions. A plurality of different tests may be compared. Other parameters may be applied to select the tests for comparison, such as manual selection by a user. At 612, the test execution time is preferably compared across the plurality of tests, optionally adjusted for expected test behavior. For example, if one test touched a greater number of parts of the code than another test, the expected execution time may be adjusted.

At 614, the test results are compared, for example as to whether each test succeeded or failed. At 616, the trace structures are preferably compared from the previously obtained test trace results. Optionally, a suspected cause for failure or at least differential test behavior is identified at 618.

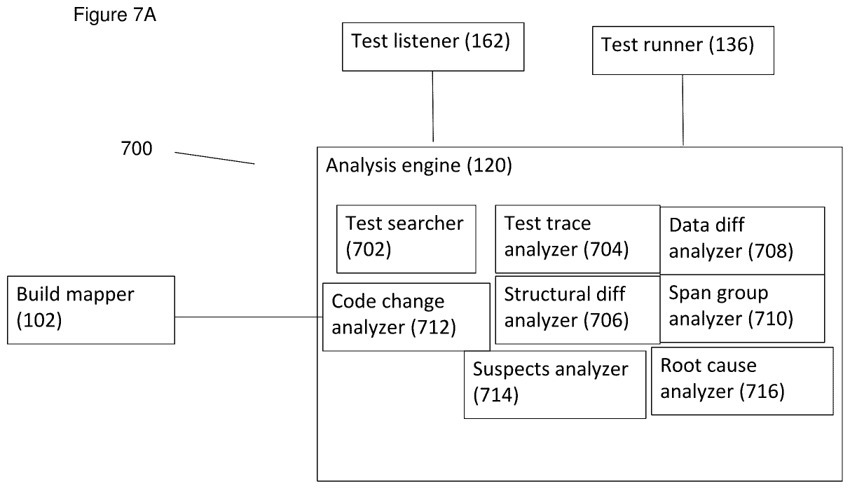

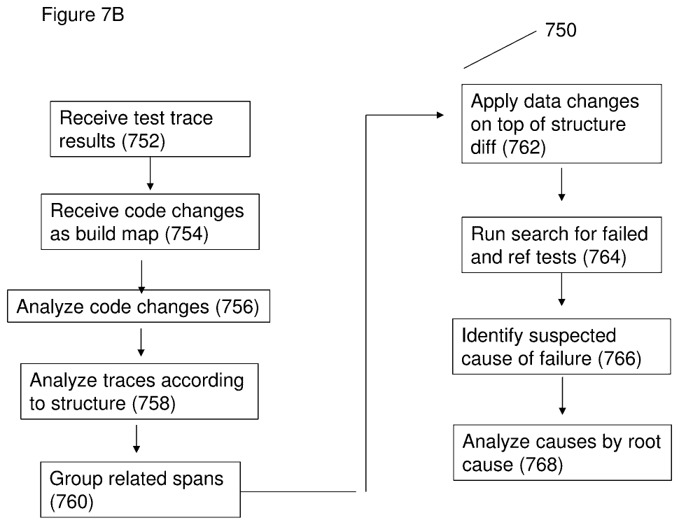

FIG. 7A shows a non-limiting, exemplary system for troubleshooting and root cause analysis. A system 700 preferably features previously described analysis engine 120, build mapper 102, test runner 136 and test listener 162. Analysis engine 120 is now shown in an exemplary, non-limiting embodiment. In this non-limiting implementation, analysis engine 120 preferably features a test searcher 702, for searching for the test to be analyzed (if a single test) or the tests to be compared (if a plurality of tests). For the latter, the plurality of tests may comprise a plurality of execution runs of the same test or different tests, or a combination thereof.

Analysis engine 120 also preferably comprises a test trace analyzer 704, which analyzes the previously described test trace results, for example from a process such as Open Telemetry. Such results are preferably provided to analysis engine 120 as previously described.

A structural diff analyzer 706 then compares the structures of test runs for a plurality of different tests and/or of a plurality of different execution runs of the same test. Structural diff analyzer 706 receives the analyzed test trace information from test trace analyzer 704, and then uses this information to determine the structural differences.

A data differential analyzer 708 also then receives the test trace analysis results from test trace analyzer 704, and determines whether particular functions or function groups (such as a button push for example) show differential behavior across the plurality of tests to be analyzed. Optionally these functions or functions groups are first assigned to spans by a span group analyzer 710. The analyzed test trace results for the spans may then be analyzed by data differential analyzer 708. Span group analyzer 710 may align spans so as group functions, that are at least similar and are preferably identical, together.

A code change analyzer 712 receives information regarding changes to the code from build mapper 102, which preferably provides a build map that includes code changes. These results may then be used to determine whether a particular test touched or related to a changed portion of the code.

The information from code change analyzer 712, data differential analyzer 708 and structural diff analyzer 706 is preferably then fed to a suspects analyzer 714. Suspects analyzer 714 preferably determines one or more suspects for differential behavior exhibited across a plurality of test execution runs, whether for the same tests, different tests or a combination thereof. Differential behavior may comprise success or failure of a test, of the code under test or a combination thereof; but may also, additionally or alternatively, relate to a difference in test and/or code performance and the like.

These suspects are preferably fed to a root cause analyzer 716, to select one or more suspects as the root cause for the differential behavior. Either or both of suspects analyzer 714 and root cause analyzer 716 may comprise an Al engine as described herein, trained on similar data to the supplied data.

FIG. 7B shows a non-limiting, exemplary method for troubleshooting and root cause analysis, which may for example be implemented with the troubleshooting system of FIG. 7A. As shown, a method 750 begins at 752, when the previously described test trace results are received (for example, from Open Telemetry or another suitable method). At 754, code changes are received as a build map, for example from the previously described build mapper. These code changes are then analyzed at 756, preferably to at least determine which test(s) touched or related to changed code.

At 758, the test trace results or traces are preferably analyzed according to structure, for example as previously described. Related spans are preferably grouped at 760, for example as previously described. Data changes are then preferably applied on top of the structure diff (differences between trace structures), more preferably according to the grouped spans, at 762. Next at 764, a search is preferably performed for at least reference test(s), comprising one or more tests according to which a comparison is to be made. Optionally a search is performed for one or more failed tests, and/or other tests to be analyzed.

At 766, a suspected cause of failure or at least of differential test and/or code under test behavior is identified. At 768, one or more suspected causes are analyzed to determine a root cause for the behavior or for the failure.

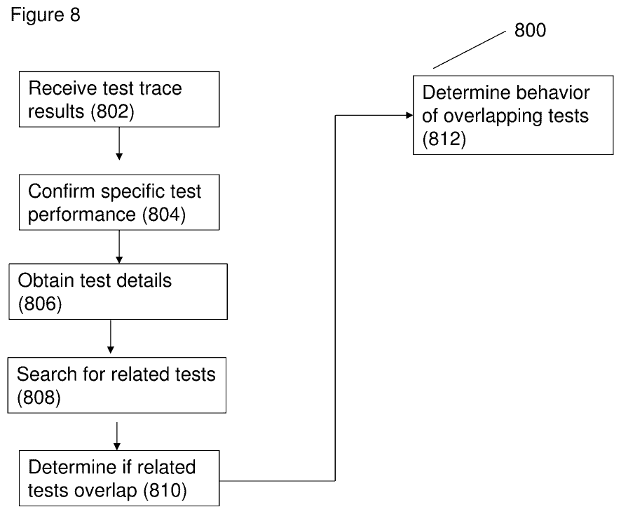

FIG. 8 shows a non-limiting, exemplary method for analyzing a plurality of tests to determine behavior of overlapping tests. Overlapping tests are of interest for a variety of reasons, including without limitation test impact analytics (for example, to reduce overhead and resources required for testing) and differential test behavior. The latter may be due to differences between execution environment and/or parameters, an unreliable or “flaky” test, and the like.

A method 800 begins by receiving test trace results at 802, for example as previously described. Next the performance of a particular test is confirmed at 804. The test may be selected according to one or more manual (user) criteria, the fact that a test showed differential behavior at a particular execution run, test failure, a test that touched a changed part of the code, and/or some combination of selection parameters.

At 806, the test details are obtained as previously described. At 808, a search is performed for one or more related tests. The tests may be determined to be related as the touching the same code or adjacent code as the previously described particular test, due to differential behavior of the test, test failure, and/or some combination of selection parameters.

At 810, it is determined whether the related test(s) overlap with the selected test. For example, overlap may be determined according to whether the tests touch the same or related code, or for other criteria. At 812, the behavior of the overlapping tests is analyzed, for example to determine whether a root cause or suspected root cause may be identified for the behavior of these tests.

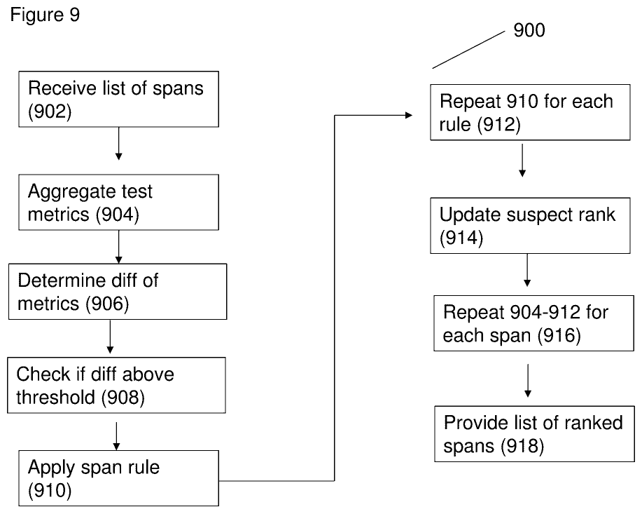

FIG. 9 shows a non-limiting, exemplary method for span analysis. As shown, a method 900 begins at 902, with receiving a list of spans. Each span comprises a particular function or group of functions, such as a GUI (graphical user interface) gadget, such as a button on the user interface for example. As a non-limiting example, an interaction of the software end user with the button, and the result of such an interaction, would be detected and included in the span.

At 904, a plurality of test metrics is aggregated. These test metrics include test results, such as with regard to success or failure of the test and/or of the code under test; test behavior, such as speed of execution, elapsed time, and so forth; or a combination thereof. At 906, a differential across the test metrics for different test execution runs is determined. At 908, this differential is compared to a threshold, to see whether it is above the threshold. The threshold may relate to a minimum level required for significance, for example. At 910, a span rule is applied to the test metrics for which the results are optionally above the threshold. The span rule may be determined manually, according to analysis of historical data, through application of an AI engine, or a combination thereof. At 912, stage 910 is preferably repeated for each rule. A combination of the results of application of each rule is preferably used to determine a suspect score for the span. The suspect score is preferably used to determine the relative rank for the span among other spans which have undergone this analysis, at 914. Preferably, as each span receives a suspect score, this score is used to adjust the relative rank of one or more other spans.

At 916, stages 904-912 are repeated for each span. At 918, a list of ranked spans is preferably provided.

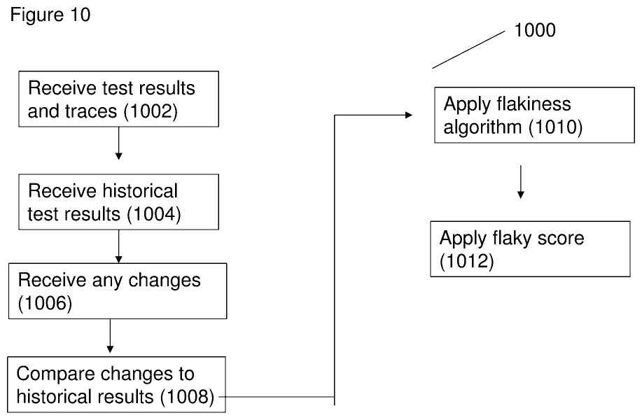

FIG. 10 shows a non-limiting, exemplary method for flaky test detection. A method 1000 preferably begins at 1002, when the previously described test results and traces are received. At 1004, the historical test results are preferably received, optionally for the same tests, alternatively or additionally for different tests that at least partially touch the same or adjacent portions of code. At 1006, any changes to the code are preferably also received. At 1008, the changes to the code are compared to the historical results. At 1010, the flakiness algorithm is applied to determine whether issues with test results are due to the code being tested or the test itself. At 1012, the flakiness score is determined.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for determining a root cause of a behavior of code during a first test, the system comprising a test listener computational device for receiving a first test result of the first test; a backend computational device for analyzing a behavior of the code during the test according to an analysis of a plurality of functions, and a computer network for connecting said test listener computational device to said backend computational device;
wherein said backend computational device comprises a memory storing a plurality of instructions and a processor for executing said instructions for selecting a second test result of a second test; comparing said first test result of said first test to said second test result of said second test; analyzing a plurality of functions of the code during each of said first and second tests; and
determining a root cause for a difference in said test results according to said plurality of functions.

2. The system of claim 1, wherein said first and second tests are different runs of the same test; wherein behavior of the same test varies over multiple runs, such that said root cause is determined to be flakiness of the same test.

3. The system of claim 1, wherein said first and second tests are different tests, wherein at least one of said first and second tests exhibits different behavior, such that said backend computational device analyzes said plurality of functions to determine a reason for said different behavior.

4. The system of claim 3, wherein said backend computational device analyzes said plurality of functions according to open telemetry.

5. The system of claim 4, wherein said backend computational device first groups said plurality of functions into a plurality of spans, and then analyzes said plurality of functions according to said test results.

6. The system of claim 5, wherein said different behavior comprises failure of at least one test.

7. The system of claim 1, wherein the backend computational device is further configured to utilize a build mapper to correlate test results with code changes.

8. The system of claim 7, wherein the build mapper is configured to determine relevance of tests based on code coverage and changes in the code.

9. The system of claim 8, wherein the build mapper includes a machine learning analyzer configured to apply a machine learning model to determine the relevance of tests to specific code sections; wherein the machine learning analyzer is further configured to receive information from a history analyzer and a statistical analyzer to inform the machine learning model.

10. The system of claim 1, wherein the backend computational device is further configured to perform test impact analysis to recommend tests for execution based on a policy set by a user.

11. The system of claim 10, wherein the policy includes criteria based on test execution frequency, time frames, and code usage in production.

12. The system of claim 1, wherein the backend computational device is further configured to utilize an analysis engine to analyze test results and determine underlying behavior of the code under test.

13. The system of claim 1, wherein the backend computational device is further configured to compare test results to a threshold and apply span rules to determine a suspect score for test behavior.

14. A method for analyzing software test results to determine a root cause of a particular behavior in code, the method comprising:
receiving, by a test listener computational device, a test result from a software test;
analyzing, by a backend computational device, behavior of the code during the software test based on a plurality of functions;
selecting, by the backend computational device, a second test result from a second software test;
comparing, by the backend computational device, the test result from the software test to the second test result;
analyzing, by the backend computational device, the plurality of functions of the code during each of the software test and the second software test; and
determining, by the backend computational device, a root cause for a difference in the test results based on the plurality of functions.

15. The method of claim 14, wherein the software test and the second software test are different executions of the same test, and the method further comprises determining flakiness of the software test based on variability in behavior over multiple test executions.

16. The method of claim 14, wherein the software test and the second software test are different tests, and the method further comprises analyzing the plurality of functions to determine a reason for different behavior between the tests.

17. The method of claim 16, wherein the analyzing of the plurality of functions is performed using open telemetry.

18. The method of claim 17, wherein the method further comprises grouping the plurality of functions into spans and analyzing the functions based on the test results.

19. The method of claim 14, wherein the method further comprises utilizing a build mapper to correlate test results with code changes.

20. The method of claim 19, wherein the build mapper determines relevance of tests based on code coverage and changes in the code, and the method further comprises applying a machine learning model to determine the relevance of tests to specific code sections.
